(19) United States
(12) Patent Application Publication
(10) Pub. No.: US 2013/0249782 A1
(43) Pub. Date: Sep. 26, 2013

(54) ELECTROPHORETIC DISPLAY MODULE AND OPERATING METHOD THEREOF AND ELECTROPHORETIC DISPLAY SYSTEM USING THE SAME

(71) Applicant: SIPIX TECHNOLOGY INC., Taoyuan County (TW)

(72) Inventors: Chain-Tin Wu, Taoyuan County (TW); Ming-Jong Jou, Hsinchu City (TW); Yao-Jen Hsieh, Hsinchu County (TW); Chi-Mao Hung, Hsinchu City (TW); Wei-Min Sun, Taipei City (TW)

(73) Assignee: SiPix Technology Inc., Taoyuan County (TW)

(21) Appl. No.: 13/736,971

(22) Filed: Jan. 9, 2013

(30) Foreign Application Priority Data
Mar. 26, 2012 (TW) 101110356

(51) Int. Cl. G09G 3/34

(52) U.S. Cl. CPC G09G 3/344
USPC 345/107

(57) ABSTRACT

An electrophoretic display module and an operating method thereof and an electrophoretic display system using the same are provided. The electrophoretic display system includes an electronic device and the electrophoretic display module. The electronic device is configured to transmit a data wireless signal and a power wireless signal, wherein a frequency of the power wireless signal is smaller than a frequency of the data wireless signal. The electrophoretic display module is configured to receive the data wireless signal and the power wireless signal, transform the power wireless signal into an operating power, and perform a predetermined operation according to the data wireless signal.

### CROSS-REFERENCE TO RELATED APPLICATION

This application claims the priority benefit of Taiwan application serial no. 101110356, filed on Mar. 26, 2012. The entirety of the above-mentioned patent application is hereby incorporated by reference herein and made a part of this specification.

### BACKGROUND OF THE INVENTION

1. Field of the Invention

The invention generally relates to an electrophoretic display module and an operating method thereof and an electrophoretic display system using the same, and more particularly, to a electrophoretic display module which transmits data and power in a wireless manner and an operating method thereof and an electrophoretic display system using the same.

2. Description of Related Art

In recent years, different display techniques have been developing quickly. Various display products, such as electrophoretic display, liquid crystal display (LCD), plasma display, and organic light-emitting diode (OLED) display, have been gradually commercialized and broadly applied. Besides, displays are increasingly desired in consumable products, such as e-signages, e-tags, e-books, smart cards, and e-POPs. Because electrophoretic display offers very low power consumption, some manufacturers apply the electrophoretic display technique in e-tag systems. In this case, an electrophoretic display system includes an electronic device and an electrophoretic display module. In order to allow the electrophoretic display module to work properly, a battery is usually installed in the electrophoretic display module for supplying power required by the operation of the display panel. However, by installing a battery in an electrophoretic display module, the manufacturing cost of the electrophoretic display module is increased, and the lifespan of the electrophoretic display module is shortened along with the deterioration of the battery.

### SUMMARY OF THE INVENTION

Accordingly, the invention is directed to an electrophoretic display module and an operating method thereof and an electrophoretic display system using the same. The manufacturing cost of the electrophoretic display module is effectively reduced and the lifespan of the electrophoretic display module is effectively prolonged.

An embodiment of the invention provides an electrophoretic display module including a module transceiving unit, a display panel, a display driving unit, and a module control unit. The module transceiving unit receives a data wireless signal and a power wireless signal and generates a power according to the power wireless signal, wherein the frequency of the power wireless signal is smaller than the frequency of the data wireless signal. The display driving unit is electrically connected to the display panel and the module transceiving unit. The display driving unit receives the power and drives the display panel. The module control unit is electrically connected to the module transceiving unit and the display driving unit. The module control unit receives the power and controls the display driving unit according to the data wireless signal to drive the display panel to execute a predetermined operation.

An embodiment of the invention provides an electrophoretic display system including an electronic device and the electrophoretic display module described above. The electronic device transmits the data wireless signal and the power wireless signal, wherein the frequency of the power wireless signal is smaller than the frequency of the data wireless signal.

An embodiment of the invention provides an operating method of an electrophoretic display module. The operating method includes following steps. A data wireless signal and a power wireless signal are received, wherein the frequency of the power wireless signal is smaller than the frequency of the data wireless signal. The power wireless signal is transformed into an operating power. A predetermined operation is executed according to the data wireless signal.

As described above, embodiments of the invention provide an electrophoretic display system, an electrophoretic display module, and an operating method of the electrophoretic display module, in which data and power are transmitted to the electrophoretic display module at the same time in a wireless manner. Thereby, the manufacturing cost of the electrophoretic display module is reduced and the lifespan of the electrophoretic display module is prolonged.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an electrophoretic display system according to an embodiment of the invention.

FIG. 2 is a functional block diagram of an electrophoretic display module according to an embodiment of the invention.

FIG. 3 is a functional block diagram of an electronic device according to an embodiment of the invention.

FIG. 4 is a flowchart of an operating method of an electrophoretic display module according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

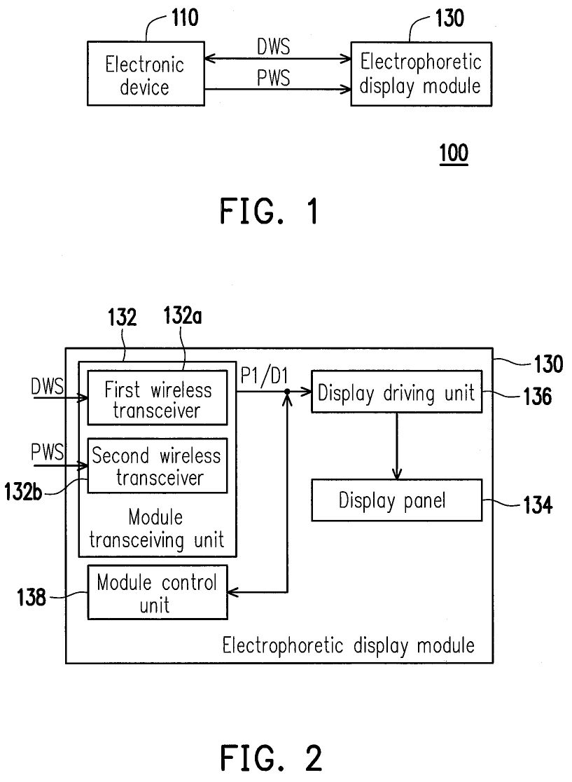

FIG. 1 is a diagram of an electrophoretic display system according to an embodiment of the invention. Referring to FIG. 1, in the present embodiment, the electrophoretic display system 100 includes an electronic device 110 and an electrophoretic display module 130. The electronic device 110 may be a handheld device. However, the invention is not limited thereto. Besides, only the electronic device 110 and the electrophoretic display module 130 are illustrated in FIG. 1 for the convenience of description. However, in actual applications, the electrophoretic display system 100 may include multiple electronic devices performing similar functions as the electronic device 110 and multiple electrophoretic display modules performing similar functions as the electrophoretic display module 130.

The electronic device 110 transmits a data wireless signal DWS and a power wireless signal PWS to the electrophoretic display module 130. It is observed from theoretical and actual experiments that the power wireless signal PWS with a higher frequency is transformed into electric power in a lower efficiency, while the power wireless signal PWS with a lower frequency is transformed into electric power in a higher efficiency. Because the power wireless signal PWS is used for transmitting power, the frequency of the power wireless signal PWS should be as low as possible. Namely, the frequency (or carrier frequency) of the power wireless signal PWS for transmitting power is smaller than the frequency (or carrier frequency) of the data wireless signal DWS. Since wavelength is in inverse proportion to frequency (i.e., the lower the frequency, the longer the wavelength), if the frequency of the power wireless signal PWS is set too low, large-sized resonant elements (for example, capacitors or inductors) have to be used in consideration of resonance processing. As a result, the size of the product is increased and accordingly the portability thereof is decreased.

In an embodiment of the invention, in order to transform the power wireless signal PWS into electric power most efficiently and to satisfy aforementioned product design considerations, the frequency of the power wireless signal PWS is set between 100 kHz and 200 kHz, so that the electric power transformed by the electric power wireless signal PWS is complied with the cost-effectiveness in practice and satisfied other product design considerations.

For example, when the frequency of the data wireless signal DWS is 13.56 MHz, the frequency of the power wireless signal PWS may be 100 kHz. Besides, the electronic device 110 can transmit corresponding data wireless signal DWS and power wireless signal PWS to the electrophoretic display module 130 according to the model, batch number, or function requirement of the electrophoretic display module 130. In the present embodiment, the data wireless signal DWS may be an analog signal carrying setting information or display information.

In an embodiment of the invention, the data wireless signal DWS complies with at least one of the near field communication (NFC) standard, the radio frequency identification (RFID) standard, the wireless fidelity (Wi-Fi) standard, and the Zigbee standard. However, the invention is not limited thereto. In addition, because the frequency of the data wireless signal DWS is higher than that of the power wireless signal PWS, the electronic device 110 can transmit the power wireless signal PWS and the data wireless signal DWS to the electrophoretic display module 130 at the same time in a wireless manner.

The electrophoretic display module 130 receives the data wireless signal DWS and the power wireless signal PWS, transforms the power wireless signal PWS into an operating power, and executes a predetermined operation according to the data wireless signal DWS. For example, when the electronic device 110 approaches, the electrophoretic display module 130 receives the data wireless signal DWS and the power wireless signal PWS from the electronic device 110 and transforms the power wireless signal PWS into a power required by the operations of various components of the electrophoretic display module 130, and the electrophoretic display module 130 executes a predetermined operation according to the data wireless signal DWS. In an embodiment of the invention, the predetermined operation may set the operation mode or display mode of the electrophoretic display module 130 according to the setting information carried by the data wireless signal DWS, report the state of the electrophoretic display module 130 according to the setting information carried by the data wireless signal DWS, or display a specific display content according to the display information carried by the data wireless signal DWS. However, the invention is not limited thereto.

In other embodiments of the invention, the functions of the electronic device 110 and the electrophoretic display module 130 in the electrophoretic display system 100 may not be realized with software modules or hardware devices. Instead, the electronic device 110 and the electrophoretic display module 130 can be implemented with any software module or hardware device as long as the software module or hardware device can perform the same or similar function.

FIG. 2 is a functional block diagram of an electrophoretic display module according to an embodiment of the invention. Referring to FIG. 2, in the present embodiment, the electrophoretic display module 130 includes a module transceiving unit 132, a display panel 134, a display driving unit 136, and a module control unit 138. Herein the display panel 134 may be an electronic paper display panel. The module transceiving unit 132 receives a data wireless signal DWS and a power wireless signal PWS and generates a power P1 according to the power wireless signal PWS.

In an embodiment of the invention, the module transceiving unit 132 receives a data wireless signal DWS with a higher frequency and a power wireless signal PWS with a lower frequency. To receive signals of different frequencies, the module transceiving unit 132 further includes a first wireless transceiver 132a and a second wireless transceiver 132b. The first wireless transceiver 132a receives the data wireless signal DWS with the higher frequency and transforms the analog data wireless signal DWS into a digital data D1, wherein the data D1 contains setting information and/or display information. The second wireless transceiver 132b receives the power wireless signal PWS with the lower frequency and transforms the power wireless signal PWS into the power P1, wherein the second wireless transceiver 132b can generate the power P1 by inducing the power wireless signal PWS.

The display driving unit 136 is electrically connected to the display panel 134 and the module transceiving unit 132. The display driving unit 136 receives the power P1 and drives the display panel 134. Namely, the display driving unit 136 receives the power source P1 from the module transceiving unit 132 so as to start operating and then control the display panel 134 to display.

The module control unit 138 is electrically connected to the module transceiving unit 132 and the display driving unit 136. The module control unit 138 receives the power P1 and the data D1. The module control unit 138 also starts operating after it receives the power P1 from the module transceiving unit 132. Besides, when the data D1 contains setting information, the module control unit 138 issues a control signal according to the data D1 (corresponding to the data wireless signal DWS) to control the display driving unit 136 so that the display driving unit 136 can drive the display panel 134 to execute the predetermined corresponding operation (for example, setting the display mode of the display panel 134, setting the operation mode of the electrophoretic display module 130, or reporting the state of the electrophoretic display module 130 through the module transceiving unit 132). When the data D1 contains display information, the module control unit 138 controls the display driving unit 136 according to the data D1 to drive the display panel 134 to execute another predetermined operation (i.e., set the image displayed by the display panel 134 according to the data D1). In an embodiment of the invention, the module control unit 138 is a micro-controller or a micro-processor.

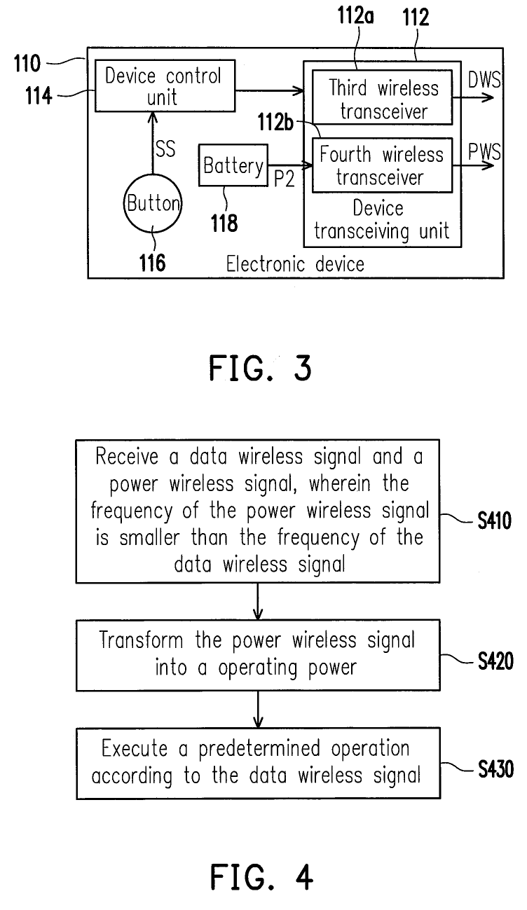

FIG. 3 is a functional block diagram of an electronic device according to an embodiment of the invention. Referring to FIG. 3, in the present embodiment, the electronic device 110 includes at least a device transceiving unit 112 and a device control unit 114. The device transceiving unit 112 transmits a data wireless signal DWS with a higher frequency and a power wireless signal PWS with a lower frequency. To transmit signals of different frequencies, the device transceiving unit 112 further includes a third wireless transceiver 112a and a fourth wireless transceiver 112b. The third wireless transceiver 112a transmits the data wireless signal DWS with the higher frequency, and the fourth wireless transceiver 112b transmits the power wireless signal PWS with the lower frequency.

The device control unit 114 is electrically connected to the device transceiving unit 112. The device control unit 114 controls the device transceiving unit 112 to transmit the data wireless signal DWS and the power wireless signal PWS. In an embodiment of the invention, the device control unit 114 is a CPU or a micro-controller.

In an embodiment of the invention, the electronic device 110 transmits the data wireless signal DWS and the power wireless signal PWS constantly, so as to supply the power required by the operation of the nearby electrophoretic display module 130. The electrophoretic display module 130 responds to the data wireless signal DWS during its operation. Thus, the electronic device 110 can detect, set, or operate the electrophoretic display module 130. However, whether the electronic device 110 is close to the electrophoretic display module 130 is determined by a user through visual observation. Thus, the electronic device 110 may be disposed with a button 116 such that the user can control the device transceiving unit 112 to transmit the data wireless signal DWS and the power wireless signal PWS. The button 116 is electrically connected to the device control unit 114 and configured to generate an initiating signal SS, so as to trigger the device control unit 114 and control the device transceiving unit 112 to transmit the data wireless signal DWS and the power wireless signal PWS.

For example, when the user presses down the button 116, the button 116 generates the initiating signal SS to trigger the device control unit 114. Then, the device control unit 114 keeps operating for a predetermined time according to the initiating signal SS and controls the device transceiving unit 112 to transmit the data wireless signal DWS and the power wireless signal PWS. However, in other embodiments, the first initiating signal SS triggers the device control unit 114 to start executing the control operations, and the second initiating signal SS triggers the device control unit 114 to stop executing the control operations. Or, when the button 116 is pressed down for the first time, it continuously outputs the initiating signal SS, and when the button 116 is pressed down for the second time, it stops outputting the initiating signal SS. In the invention, the triggering of the device control unit 114 is not limited to what described above and can be modified according to how the initiating signal SS is generated.

Thereby, the electronic device 110 is prevented from constantly transmitting the data wireless signal DWS and the power wireless signal PWS so that less power is consumed. Besides, the electronic device 110 can be controlled to transmit the power wireless signal at any time.

In an embodiment of the invention, the electronic device 110 may also be disposed with one or more batteries 118 for supplying power required by the transmission of the power wireless signal PWS. In the present embodiment, only one battery 118 is illustrated as an example. However, the invention is not limited thereto. Namely, in another embodiment of the invention, the electronic device 110 may include multiple batteries 118. In the present embodiment, the battery 118 is served as the source of power for the device transceiving unit 112 to transmit the power wireless signal PWS. In other words, the device transceiving unit 112 transmits the power wireless signal PWS by using the power P2 supplied by the battery 118. It should be mentioned that in the present embodiment, the battery 118 is a portable power supply (for example, a mobile power source).

FIG. 4 is a flowchart of an operating method of an electrophoretic display module according to an embodiment of the invention. Referring to FIG. 4, in step S410 of the present embodiment, a data wireless signal and a power wireless signal are received, wherein the frequency of the power wireless signal is smaller than the frequency of the data wireless signal. In step S420, the electric power wireless signal is transformed into an operating power. In step S430, a predetermined operation is executed according to the data wireless signal. The details of foregoing steps can be understood by referring to the embodiments illustrated in FIGS. 1-3 therefore will not be described herein.

As described above, embodiments of the invention provide an electrophoretic display system, an electrophoretic display module, and an operating method of the electrophoretic display module, in which an electronic device transmits a data wireless signal of a higher frequency and a power wireless signal of a lower frequency to the electrophoretic display module at the same time, and the electrophoretic display module transforms the power wireless signal into an operating power. Thereby, the manufacturing cost of the electrophoretic display module is reduced, and the lifespan of the electrophoretic display module is prolonged.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electrophoretic display system, comprising:
an electronic device, transmitting a data wireless signal and a power wireless signal, wherein a frequency of the power wireless signal is smaller than a frequency of the data wireless signal; and
an electrophoretic display module, receiving the data wireless signal and the power wireless signal, transforming the power wireless signal into an operating power, and executing a predetermined operation according to the data wireless signal.

2. The electrophoretic display system according to claim 1, wherein the electrophoretic display module comprises:
a module transceiving unit, receiving the data wireless signal and the power wireless signal, and generating the operating power according to the power wireless signal;
a display panel;
a display driving unit, electrically connected to the display panel and the module transceiving unit, receiving the operating power, and driving the display panel; and
a module control unit, electrically connected to the module transceiving unit and the display driving unit, receiving the operating power, and controlling the display driving unit according to the data wireless signal to drive the display panel to execute the predetermined operation.

3. The electrophoretic display system according to claim 2, wherein the display panel is an electronic paper display panel.

4. The electrophoretic display system according to claim 2, wherein the module transceiving unit comprises:
a first wireless transceiver, receiving the data wireless signal; and
a second wireless transceiver, receiving the power wireless signal, and generating the operating power according to the power wireless signal.

5. The electrophoretic display system according to claim 1, wherein the electronic device comprises:
a device transceiving unit, transmitting the data wireless signal and the power wireless signal; and
a device control unit, electrically connected to the device transceiving unit, and controlling the device transceiving unit to transmit the data wireless signal and the power wireless signal.

6. The electrophoretic display system according to claim 5, wherein the device transceiving unit comprises:
a third wireless transceiver, transmitting the data wireless signal; and
a fourth wireless transceiver, transmitting the power wireless signal.

7. The electrophoretic display system according to claim 5, wherein the electronic device further comprises a button, and the button is configured to generate an initiating signal to trigger the device control unit so that the device control unit controls the device transceiving unit to transmit the data wireless signal and the power wireless signal.

8. The electrophoretic display system according to claim 5, wherein the electronic device further comprises a battery for supplying a power, and the device transceiving unit transmits the power wireless signal by using the power.

9. The electrophoretic display system according to claim 1, wherein the frequency of the power wireless signal is between 100 kHz and 200 kHz.

10. The electrophoretic display system according to claim 1, wherein the data wireless signal complies with at least one of a near field communication (NFC) standard, a radio frequency identification (RFID) standard, a wireless fidelity (Wi-Fi) standard, and a Zigbee standard.

11. An electrophoretic display module, comprising:
a transceiving unit, receiving a data wireless signal and a power wireless signal, and transforming the power wireless signal into an operating power, wherein a frequency of the power wireless signal is smaller than a frequency of the data wireless signal;
a display panel;
a display driving unit, electrically connected to the display panel and the transceiving unit, receiving the operating power, and driving the display panel; and
a control unit, electrically connected to the transceiving unit and the display driving unit, receiving the operating power, and controlling the display driving unit according to the data wireless signal to drive the display panel to execute the predetermined operation.

12. The electrophoretic display module according to claim 11, wherein the display panel is an electronic paper display panel.

13. The electrophoretic display module according to claim 11, wherein the transceiving unit comprises:
a first wireless transceiver, receiving the data wireless signal; and
a second wireless transceiver, receiving the power wireless signal, and generating the operating power according to the power wireless signal.

14. The electrophoretic display module according to claim 11, wherein the frequency of the power wireless signal is between 100 kHz and 200 kHz.

15. The electrophoretic display module according to claim 11, wherein the data wireless signal complies with at least one of a near field communication (NFC) standard, a radio frequency identification (RFID) standard, a wireless fidelity (Wi-Fi) standard, and a Zigbee standard.

16. An operating method of an electrophoretic display module, comprising:
receiving a data wireless signal and a power wireless signal, wherein a frequency of the power wireless signal is smaller than a frequency of the data wireless signal;
transforming the power wireless signal into an operating power;
executing a predetermined operation according to the data wireless signal.

17. The operating method according to claim 16, wherein a frequency of the power wireless signal is smaller than or equal to 200 kHz.

18. The operating method according to claim 16, wherein the data wireless signal complies with at least one of a near field communication (NFC) standard, a radio frequency identification (RFID) standard, a wireless fidelity (Wi-Fi) standard, and a Zigbee standard.
